(19) United States
(12) Patent Application Publication
(10) Pub. No.: US 2024/0112197 A1
(43) Pub. Date: Apr. 4, 2024

(54) Artificial Intelligence Based Topic Detection

(71) Applicant: Bank of America Corporation, Charlotte, NC (US)

(72) Inventor: Mahesha Bharatha Herath, Concord, NC (US)

(21) Appl. No.: 17/957,340

(22) Filed: Sep. 30, 2022

(51) Int. Cl. G06Q 30/00; G06F 16/28; G06F 40/20; G06N 20/00

(52) U.S. Cl. CPC G06Q 30/016; G06F 16/285; G06F 40/20; G06N 20/00

(57) ABSTRACT

Arrangements for providing emerging topic detection are provided. In some aspects, customer issue data may be received. For instance, voice data from customer and customer service associate interactions may be received. The customer issue data may be converted to text data and the text data may be further analyzed. For instance, a first body of terms for a first time period and a second body of terms for a second time period after the first time period may be generated. The generated first body of terms may be subtracted from the second body of terms to generate filtered terms. The filtered terms may then be further analyzed using, for instance, Latent Dirichlet Allocation (LDA) to identify emerging terms that may then be categorized and stored in one or more databases. In some examples, emerging terms and/or associated categories may be transmitted to a computing device for display on a dashboard.

### BACKGROUND

Aspects of the disclosure relate to electrical computers, systems, and devices for providing artificial intelligence-based topic detection.

Enterprise organizations often have customer service centers staffed by a plurality of customer service associates that may receive hundreds of thousands of customer interactions per year. For instance, customers may call with various issues related to accounts, enterprise organization tools such as websites, apps, and the like, requests for service, and the like. Particularly for calls made via a telephone channel, it may be difficult to track or identify topics that are increasing in frequency (e.g., emerging topics), particularly when these topics are new or otherwise uncategorized. Accordingly, aspects described herein are directed to using artificial intelligence and machine learning to detect and label emerging topics.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with detecting and labeling emerging topics in customer issue data.

In some aspects, customer issue data may be received. For instance, voice data from customer and customer service associate interactions may be received. The voice data may include identification (e.g., in speech format) of an issue for which the customer is requesting service. The customer issue data may be converted to text data and the text data may be further analyzed.

For instance, a first body of terms for a first time period and a second body of terms for a second time period after the first time period may be generated. In generating the bodies of terms, the text data may be pre-processed to convert text to lowercase, remove special characters, remove stop words, and the like. The generated first body of terms may be subtracted from the second body of terms to generate filtered terms. In some examples, generating the bodies of terms may include generating a first document index for the first time period and a second document index for the second time period and subtracting the first document index from the second document index to identify the filtered terms.

The filtered terms may then be further analyzed using, for instance, Latent Dirichlet Allocation (LDA) to identify emerging terms that may then be categorized or labeled and stored in one or more databases. In some examples, emerging terms and/or associated categories or labels may be transmitted to a computing device for display on, for instance, a dashboard.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing emerging topic detection functions in accordance with one or more aspects described herein;

FIGS. 2A-2D depict an illustrative event sequence for implementing emerging topic detection functions in accordance with one or more aspects described herein;

FIG. 3 illustrates an illustrative method for implementing emerging topic detection functions according to one or more aspects described herein; and

FIG. 4 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, enterprise organizations often have customer service departments that receive hundreds of thousands of customer interactions per year. Given the volume of interactions, it may be difficult to identify and track new topics or topics that are occurring more frequently than in the past.

Accordingly, as discussed more fully herein application artificial intelligence and machine learning to identify emerging topics. In some examples, customer data may be received. For instance, as customers call a customer service associate and interact with those associates, data of the call may be received. In some examples, the data may include voice data of the customer and associate. The customer data may then be converted to text data using, for instance, natural language processing, and an issue associated with the interaction may be identified in the text data. For instance, customers may call with a complaint about a transaction, a request for a new card, a question about a product or service, or the like. This data may be converted to text for further analysis.

In some examples, a body of terms may be generated for one or more time periods. For instance, an enterprise organization may want to identify emerging topics in the month of March. Accordingly, a body of terms for the month of February may be generated and a body of terms for the month of March may be generated. The body of terms from February may be subtracted from the body of terms for March to identify emerging terms (e.g., terms found in the March data but not in the February data). The emerging terms (or filtered terms) may be analyzed using, for instance, Latent Dirichlet Allocation (LDA) to identify emerging topics associated with the emerging terms. Those topics may then be stored and/or transmitted for display, further analysis, and the like.

These and various other arrangements will be discussed more fully below.

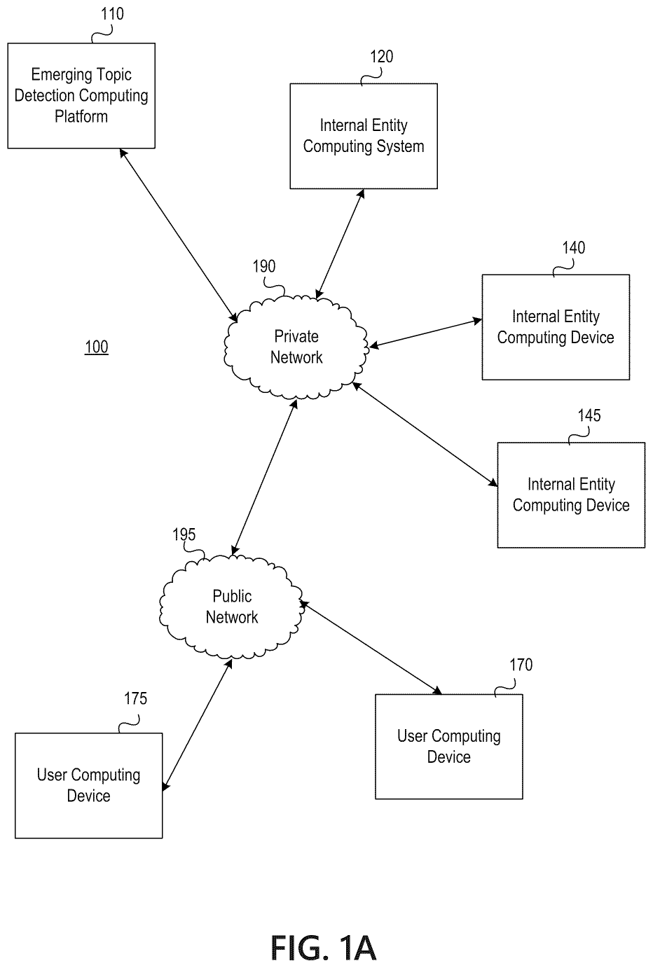

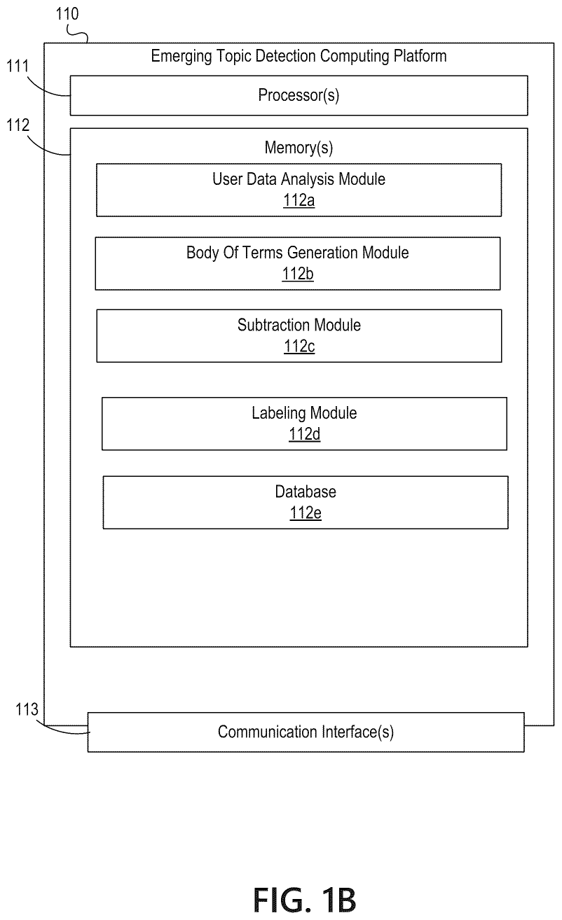

Aspects described herein may be implemented using one or more computing devices operating in a computing environment. For instance, FIGS. 1A-1B depict an illustrative computing environment for implementing emerging topic identification functions in accordance with one or more aspects described herein. Referring to FIG. 1A, computing environment 100 may include one or more computing devices and/or other computing systems. For example, computing environment 100 may include emerging topic detection computing platform 110, internal entity computing system 120, internal entity computing device 140, internal entity computing device 145, user computing device 170, and/or user computing device 175. Although one internal entity computing systems 120, two internal entity computing devices 140, 145 and two user computing devices 170, 175 are shown, any number of systems or devices may be used without departing from the invention.

Emerging topic detection computing platform 110 may be configured to perform intelligent, dynamic, and efficient emerging topic detection in, for instance, call center work processes. In some examples, emerging topic detection computing platform 110 may receive voice data from a call center conversation between a user and a call center associate. For instance, the voice data including the user's request for assistance, response from a call center associate, and the like, may be received. The voice data may be transcribed (e.g., using natural language processing) to digitized text data for further analysis. In some examples, transcribing the voice data may be performed by one or more other systems, such as internal entity computing system 120, which may execute or host one or more applications used by call center associates (e.g., via call center associate computing devices such as internal entity computing device 140, internal entity computing device 145, or the like) to receive and address customer requests for service.

Emerging topic detection computing platform 110 may analyze the digitized text data to generate or build a body of terms. For instance, the text may be analyzed and/or filtered to remove various stop words (e.g., an, the, or the like), remove repeating words, and the like, to build a body of terms. This process may be performed for a first time period and a second, subsequent time period. For instance, text data for a first time period may be analyzed to build a body of terms for the first time period and text data for the second time period may be analyzed to build the body of terms for the second time period.

Emerging topic detection computing platform 110 may then process the body of terms for the first time period and the body of terms for the second time period to identify terms only appearing in the body of terms in the second time period. For instance, the body of terms in the first time period may be “subtracted” from the body of terms in the second time period (e.g., terms appearing in the first time period may be removed from the body of terms in the second time period) to result in only terms appearing in the second time period. These terms may be considered “emerging topics,” as they are appearing only in, for instance, a time period more recent than the first time period.

Emerging topic detection computing platform 110 may execute a machine learning model to analyze the emerging topics and identify a label for the topics. The label may represent a category of, for instance, customer service requests associated with the topics. The label may then be added to a database of labels that may be used to categorize subsequently received customer service requests in that category and may also be used to further investigate most recent topics being raise via, for instance, customer service requests.

Internal entity computing system 120 may be or include one or more computing devices or systems (e.g., servers, server blades, or the like) including one or more computer components (e.g., processors, memory, or the like) that may host or execute one or more applications of an enterprise organization that may, for instance, be used in receiving and address customer requests for service. For instance, users may contact a customer service associate to request assistance (e.g., identify a website outage, request assistance with an account, or the like). In some examples, these interactions may be via telephone (e.g., a customer or user may call a customer service representative). The customer service representative may interact with internal entity computing system 120 via an associate computing device, such as internal entity computing device 140, internal entity computing device 145, to input data associated with the service request, identify a category of service request, provide a recommended solution to the user, or the like. Data associated with customer requests for service may be stored in a database associated with internal entity computing system 120 and information to facilitate customer service associate input of data related to a request (e.g., options for categorizing customer requests for service) may be stored in the database at internal entity computing system 120. In some examples, internal entity computing system 120 may be a same device or integrated with emerging topic detection computing platform 110 (e.g., a same physical device) or may they may be separate devices that are in communication with each other.

Internal entity computing device 140 and/or internal entity computing device 145, may be or include computing devices (e.g., laptop computing devices, desktop computing devices, tablet computing devices, mobile computing devices, and the like) operated by an enterprise organization associate (e.g., customer service representative) during the course of address customer service requests. Internal entity computing device and/or internal entity computing device 145 may communicate with internal entity computing system 120 to receive and respond to customer service requests.

User computing device 170 and/or user computing device 175 may be or include one or more user computing devices (e.g., smart phones, wearable devices, laptops, desktops, tablets, or the like) that may be used (e.g., by an employee of the enterprise organization, by a customer of the enterprise organization, or the like) to request customer service. For instance, a customer or user may contact, via a telephone channel of user computing device 170, 175, a customer service associate who may operate internal entity computing device 140 or internal entity computing device 145 to address a customer service request.

As mentioned above, computing environment 100 also may include one or more networks, which may interconnect one or more of emerging topic detection computing platform 110, internal entity computing system 120, internal entity computing device 140, internal entity computing device 145, user computing device 170 and/or user computing device 175. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, emerging topic detection computing platform 110, internal entity computing system 120, internal entity computing device 140, internal entity computing device 145, may be associated with an enterprise organization (e.g., a financial institution), and private network 190 may be associated with and/or operated by the organization, and may include one or more networks (e.g., LANs, WANs, virtual private networks (VPNs), or the like) that interconnect emerging topic detection computing platform 110, internal entity computing system 120, internal entity computing device 140, internal entity computing device 145, and one or more other computing devices and/or computer systems that are used by, operated by, and/or otherwise associated with the organization. Public network 195 may connect private network 190 and/or one or more computing devices connected thereto (e.g., emerging topic detection computing platform 110, internal entity computing system 120, internal entity computing device 140, internal entity computing device 145) with one or more networks and/or computing devices that are not associated with the organization. For example, user computing device 170 and/or user computing device 175, might not be associated with an organization that operates private network 190 (e.g., because user computing device 170 and/or user computing device 175 may be owned, operated, and/or serviced by one or more entities different from the organization that operates private network 190, one or more customers of the organization, one or more employees of the organization, public or government entities, and/or vendors of the organization, rather than being owned and/or operated by the organization itself), and public network 195 may include one or more networks (e.g., the internet) that user computing device 170 and/or user computing device 175 to private network 190 and/or one or more computing devices connected thereto (e.g., emerging topic detection computing platform 110, internal entity computing system 120, internal entity computing device 140, internal entity computing device 145).

Referring to FIG. 1B, emerging topic detection computing platform 110 may include one or more processors 111, memory 112, and communication interface 113. A data bus may interconnect processor(s) 111, memory 112, and communication interface 113. Communication interface 113 may be a network interface configured to support communication between emerging topic detection computing platform 110 and one or more networks (e.g., private network 190, public network 195, or the like). Memory 112 may include one or more program modules having instructions that when executed by processor(s) 111 cause emerging topic detection computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of emerging topic detection computing platform 110 and/or by different computing devices that may form and/or otherwise make up emerging topic detection computing platform 110.

For example, memory 112 may have, store and/or include user data analysis module 112a. User data analysis module 112a may store instructions and/or data that may cause or enable the emerging topic detection computing platform 110 to receive user data, such as user interaction data from a customer service request (e.g., voice data related to a customer service interaction) and process the data. Processing the data may include using natural language processing to transcribe or convert the voice data to digitized text data. The data for a plurality of user or customer interactions may be processed to obtain a record of a plurality of user interactions (e.g., over time).

Emerging topic detection computing platform 110 may further have, store and/or include body of terms generation module 112b. Body of terms generation module 112b may store instructions and/or data that may cause or enable the emerging topic detection computing platform 110 to analyze the digitized text data to build a vocabulary or body of terms found in the digitized text data from a first time period and a second, subsequent time period. For instance, a first body of terms may be generated for terms identified in a first month of data and a second body of terms may be generated for terms identified in a second, subsequent month of data. In some examples, the second month may be the month immediately following the first month. In some examples, preprocessing of text data may be performed to remove stop words, remove special characters, change all words to lower case, and the like, in order to generate the body of terms. In some examples, generating the body of terms for different time periods may include generating a document term matrix representing terms (e.g., which terms, number of appearances, and the like) appearing in each document (e.g., each text description of associate and customer interactions) for each time period.

Emerging topic detection computing platform 110 may further have, store and/or include subtraction module 112c. Subtraction module 112c may store instructions and/or data that may cause or enable the emerging topic detection computing platform 110 to identify differences in the body of terms from the first time period and the body of terms from the second time period. For instance, the terms of the first period may be “subtracted” or otherwise filtered or removed from the terms of the second period to identify emerging topics (e.g., terms appearing in a more recent time period but not in an earlier time period than the more recent time period). In some examples, a document term matrix for a first time period may be subtracted from a document matrix of a second time period to identify a filtered set of documents (e.g., a filtered set of text descriptions of associate and customer interactions).

Emerging topic detection computing platform 110 may further have, store and/or include labeling module 112d. Labeling module 112d may store instructions and/or data that may cause or enable the emerging topic detection computing platform 110 to perform Latent Dirichlet Allocation (LDA) analysis to identify topics occurring in different documents (e.g., in a text description of an associate and customer interaction) for particular time periods. For instance, the documents (e.g., text descriptions of interactions between associate and customer) that were filtered out because they appear in both document matrices may be processed using LDA to identify terms associated with various topics or categories of customer service requests. These may be considered recurring topics. An additional LDA analysis may be performed on the filtered set of text descriptions to identify frequently occurring terms. These frequently occurring terms may correspond to emerging topics (e.g., topics occurring in a more recent month that did not appear in an earlier month for which a data comparison is being performed). These categories may be labeled and the labels stored in a database for further user (e.g., in labeling topics that are later considered recurring).

In some examples, the LDA analysis may be performed using a machine learning model trained using unsupervised data. For instance, the machine learning model may include various unsupervised learning models that may be trained using historical associate and customer interaction data and may identify patterns or sequences in current free form text data.

Emerging topic detection computing platform 110 may further include a database 112e. Database 112e may store user data analysis results, raw user data, and the like. In some examples, database 112e may store topics identified for use in applying labels to those same topics when they appear in subsequent data.

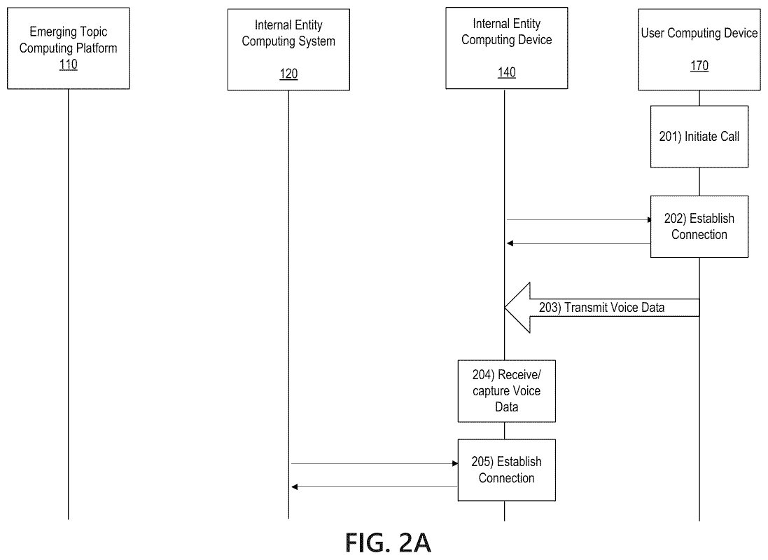

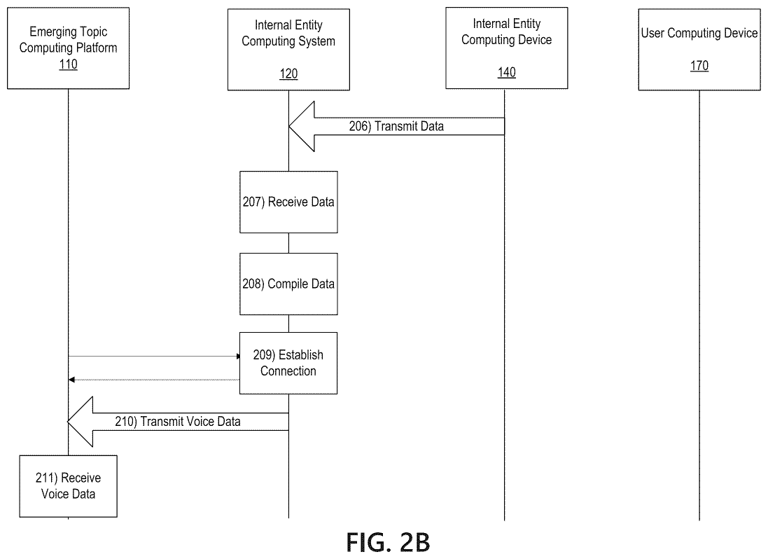

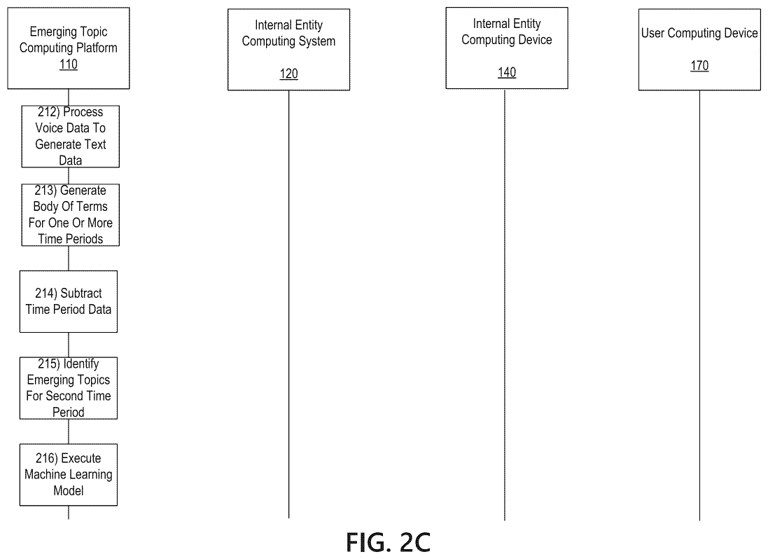

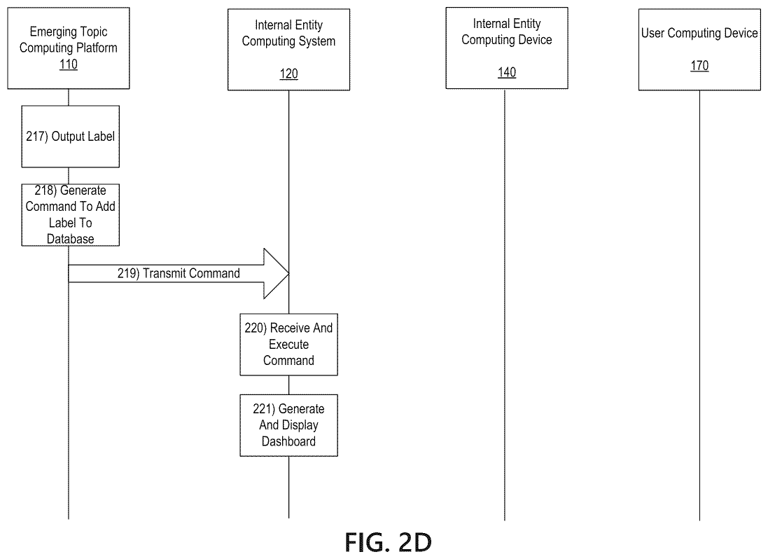

FIGS. 2A-2D depict one example illustrative event sequence for implementing emerging topic detection functions in accordance with one or more aspects described herein. The events shown in the illustrative event sequence are merely one example sequence and additional events may be added, or events may be omitted, without departing from the invention. Further, one or more processes discussed with respect to FIGS. 2A-2D may be performed in real-time or near real-time.

With reference to FIG. 2A, at step 201, user computing device 170 may initiate a call with a customer service associate at an enterprise organization. For instance, a telephone channel may be used to initiate a call with a customer service associate (or customer service associate device).

At step 202, user computing device 170 may connect to a customer service associate device, such as internal entity computing device 140. For instance, a first wireless connection may be established between user computing device 170 and internal entity computing device 140. Upon establishing the first wireless connection, a communication session may be initiated between user computing device 170 and internal entity computing device 140.

At step 203, voice data may be transmitted via the telephone channel from the user computing device 170 to the internal entity computing device 140. For instance, a request for customer service may be transmitted by the user computing device 170 to the internal entity computing device 140.

At step 204, internal entity computing device 140 may receive the voice data from the user computing device 170. Further, at step 204, voice data from the customer service associate may be captured. In some examples, additional voice or spoken data may be received from user computing device 170 and/or captured from customer service associate via internal entity computing device 140 (e.g., additional conversation may be captured).

At step 205, internal entity computing device may connect to internal entity computing system 120. For instance, a second wireless connection may be established between internal entity computing device 140 and internal entity computing system 120. Upon establishing the second wireless connection, a communication session may be initiated between internal entity computing device 140 and internal entity computing system 120.

With reference to FIG. 2B, at step 206, internal entity computing device 140 may transmit or send data to the internal entity computing system 120. For instance, internal entity computing device 140 may transmit or send voice data associated with the customer service request.

At step 207, internal entity computing system 120 may receive the data and, at step 208, may compile the data with other data from customer and associate interactions. For instance, voice data from one or more customer and associate interactions (e.g., requests for customer service) may compiled and transmitted for emerging topic processing.

At step 209, internal entity computing system 120 may connect to emerging topic detection computing platform 110. For instance, a third wireless connection may be established between internal entity computing system 120 and emerging topic detection computing platform 110. Upon establishing the third wireless connection, a communication session may be initiated between internal entity computing system 120 and emerging topic detection computing platform 110.

At step 210, the voice data (and/or other data) received by the internal entity computing system 120 may be transmitted or sent to the emerging topic detection computing platform 110. As indicated above, in some examples, compiled data received (e.g., data from all customer service requests) may be transmitted to emerging topic detection computing platform 110 (e.g., in a batch process, in a data stream, or the like). Additionally or alternatively, data associated with various interactions may be transmitted by the internal entity computing system 120 when received, rather than being compiled with data from other interactions.

At step 211, the emerging topic detection computing platform 110 may receive the data.

With reference to FIG. 2C, at step 212, the emerging topic detection computing platform 110 may process the received data. For instance, emerging topic detection computing platform 110 may use natural language processing to convert voice data to digitized text data. Accordingly, digitized text data for each customer service interaction (e.g., in one or more time periods) may be generated. In some examples, user issue data may be extracted that identifies an identified question, complaint, request, or the like, provided by the customer to the associate (e.g., “The website won't load,” “My credentials aren't working,” “I need a new card” or the like). In some examples, the text associated with the user issue data for each customer and associate interaction may be identified as a “document” for further analysis. Accordingly, in some examples, a document may refer to the text associated with a description of the issue in a customer and associate interaction.

At step 213, based on the generated text data, a body of terms for one or more time periods may be generated. For instance, emerging topic detection computing platform 110 may generate a body of terms for a first time period (e.g., a first month, a first week, or the like) and may generate a body of terms for a second time period subsequent to the first time period (e.g., a second month, a second week, or the like). For instance, the documents generated from the text data may be preprocessed to convert all letters to lowercase, remove special characters, remove stop words, identify root or stem words, and the like. This data may, in some examples, be used to generate a document matrix for each time period. The document matrix may identify which documents included which terms, a number of occurrences of each term, and the like.

At step 214, the body of terms for the first time period may be subtracted from the body of terms for the second time period to identified filtered terms that represent emerging topics (e.g., topics from the more recent time period). In some examples, the document matrix from the first time period may be subtracted from the document matrix from the second time period to identify the filtered terms that represent the emerging terms in the second time period, at step 215.

At step 216, a machine learning model may be executed. For instance, the document matrix for the first time period may be input into the machine learning model to identify recurring terms and associated topics or labels for the recurring terms. Further, the filtered terms (e.g., terms identified as emerging at step 215) may be input into the machine learning model to identify topics or labels for the emerging terms. In some examples, the machine learning model may implement Latent Dirichlet Allocation (LDA) to identify the topics or labels associated with the terms of the document matrix from the first time period and the filtered terms representing emerging terms.

With reference to FIG. 2D, at step 217, the machine learning model may output one or more labels for the emerging topics. The labels may be stored in a database 112e for use in identifying recurring topics that may be included in later-received data.

At step 218, emerging topic detection computing platform 110 may generate a command or instruction to add identified labels for emerging topics to a database of labels that may be used by customer service associates in labeling customer requests or issues.

At step 219, the command or instruction may be transmitted or sent to the internal entity computing system 120. At step 220, the command or instruction may be executed and the label may be added to a database and/or listing of available labels to categorize customer issues.

At step 221, internal entity computing system 120 may generate and display a dashboard including the identified recurring topics, identified emerging topics, and the like. This may enable administrators, analysts, and the like to identify emerging topics, conduct further research into the emerging topics, and the like.

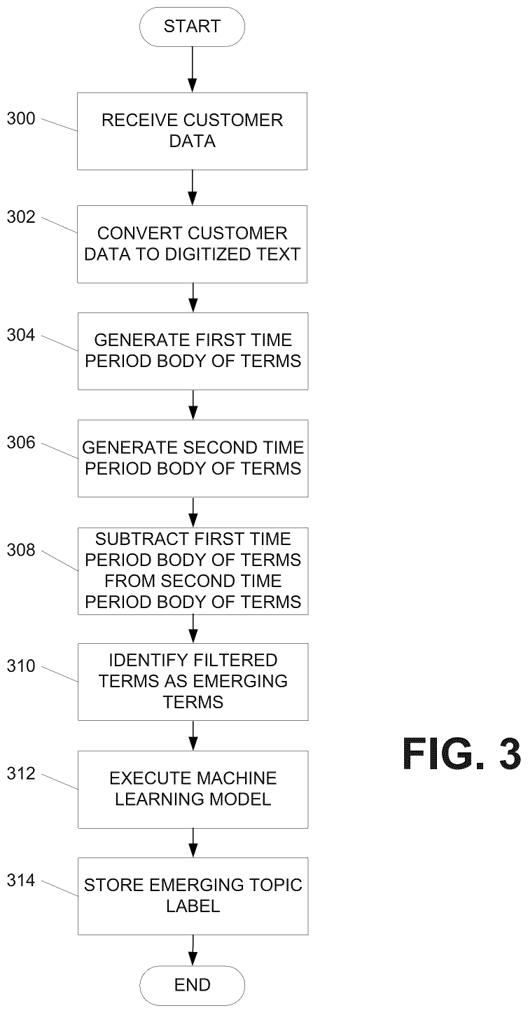

FIG. 3 is a flow chart illustrating one example method of implementing emerging topic detection functions in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, customer issue data may be received. For instance, data associated with one or more calls to one or more customer service associates may be received. The customer issue data may include voice data identifying a customer issue for each customer and associate interaction.

At step 302, the received customer data may be converted to digitized text data. In some examples, this step may be performed prior to the customer data being received and, in those examples, step 302 may be omitted. In some examples, the digitized text data may include text associated with an issue, question, complaint, or the like, identified by the customer during an interaction between the customer and the customer service associate. In some examples, each text description of a customer issue may be considered a “document” and the documents may be further analyzed.

At step 304, a first body of terms for a first time period may be generated. For instance, the documents (e.g., text data associated with customer issues) from a first time period may be pre-processed to convert text to lowercase, remove stop words (e.g., a, the, an, or the like), remove special characters, and the like. In some examples, a first document matrix may be generated including terms appearing in the documents from the first time period, number of occurrences of each term, and the like.

At step 306, a second body of terms for a second time period may be generated. For instance, the documents (e.g., text data associated with customer issues) from a second time period after the first time period may be pre-processed to convert text to lowercase, remove stop words (e.g., a, the, an, or the like), remove special characters, and the like. In some examples, a second document matrix may be generated including terms appearing in the documents from the second time period, number of occurrences of each term, and the like.

At step 308, the body of terms from the first time period may be subtracted from the body of terms from the second time period to identify filtered terms appearing in the second body of terms but not in the first body of terms. In some examples, subtracting the body of terms from the first time period from the body of terms from the second time period may include subtracting the first document matrix from the second document matrix.

At step 310, the filtered terms may be identified as emerging terms and submitted for further processing to categorize the user issues associated with the filtered terms.

At step 312, a machine learning model may be executed using the filtered terms as inputs to output an emerging topic label. For instance, one or more emerging topic labels may be generated and associated with identified customer issues (e.g., from the received customer data). These emerging topic labels may then be stored, at step 314, in, for instance, a database, and used to identify later-received recurring terms. In some examples, the emerging topic labels may be sent to a computing device for display by the computing device, for further analysis by one or more analysts or administrators, or the like.

Accordingly, aspects described herein are directed to using artificial intelligence and machine learning to detect emerging topics in, for instance, customer service issue data. While various aspects described herein are described in the context of customer service issue data, the arrangements described herein may be used to identify emerging topics in any body of data. Further, while aspects described herein are provided in the context of customer service call data, in some examples, other types of data (e.g., text input, or the like) may be used and steps associated with converting the voice data to text data may be omitted.

While aspects described herein include description of converting voice data to text data, in some examples, that conversion may result in misspelled words, incorrect grammar, and the like, in the text data. However, because the arrangement described herein provide for pre-processing of data and rely on building a body of terms, proper spelling and grammar might not be necessary to identify emerging terms and topics using the arrangements described herein.

Further, in creating the bodies of terms, by pre-processing the text data, only unique terms may be captured. For instance, pre-processing may include stemming terms or limitizing terms such that terms such as “processor” and “processing,” would only be added as one unique term, “process,” for example.

Further, aspects described herein may be used to analyze data from any two or more time periods to identify emerging topics in the time periods being compared. For instance, an enterprise organization might want to identify emerging topics in a most recent month and, accordingly, will subtract data from a time period two months ago from data from a time period one month ago to obtain the emerging topics in the most recent (e.g., last completed) month. In another example, the organization might want to compare emerging topics from a similar time period last year. Accordingly, the process may be performed on a sixty day period from this year and a same sixty day period from last year to identify and evaluate topics emerging during the time period in the current year. Various other time period may be analyzed without departing from the invention.

In some examples, in identify categories or topic labels for the emerging terms, the terms may be grouped in different topics and, in some examples, cosine similarity may be used to identify terms most relevant to a particular topic. Accordingly, in some examples, cosine similarity may be used in conjunction with LDA to identify relevant topics for the emerging terms.

Accordingly, aspects described herein provide efficient, accurate detection of emerging topics in bodies of data.

Accordingly, arrangements provided herein provide efficient and accurate reporting of API call failures to providers for mitigation. By using provider-specific encryption to provide access to data via a blockchain, the system may securely and efficiently transmit API call failure data, metadata, and the like. Further, because all provider specific failure data may be provided in a bundle, the provider may efficiently receive and begin mitigation of issues associated with the failures. Once mitigation or remediation is complete, a notification may be sent to the enterprise organization to ensure seamless operation of the application.

The arrangements discussed herein may be performed in real-time or near real-time (e.g., call logs may be continuously monitored, split, sub-logs analyzed, and the like) to ensure efficient identification of failures and transmission of failure data to providers via the blockchain. Further, by splitting the call logs by provider and providing, in at least some examples, only API call failure data to the provider, computing resources may be conserved and data may be narrowly focused on only APIs requiring issue mitigation.

In some examples, each provider may have a dashboard provided on the provider computing system that may receive and display notifications of data written to the blockchain, enable access to the blockchain data, and the like. This may aid in quickly identifying corrective actions to address failures and may enable the provider to communicate corrective actions to the enterprise organization.

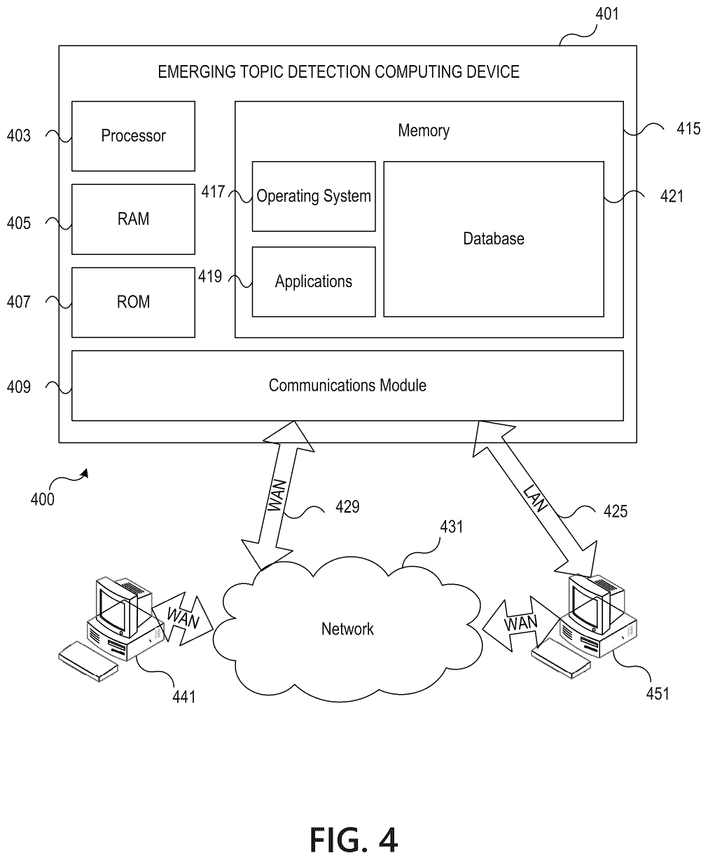

FIG. 4 depicts an illustrative operating environment in which various aspects of the present disclosure may be implemented in accordance with one or more example embodiments. Referring to FIG. 4, computing system environment 400 may be used according to one or more illustrative embodiments. Computing system environment 400 is only one example of a suitable computing environment and is not intended to suggest any limitation as to the scope of use or functionality contained in the disclosure. Computing system environment 400 should not be interpreted as having any dependency or requirement relating to any one or combination of components shown in illustrative computing system environment 400.

Computing system environment 400 may include emerging topic detection computing device 401 having processor 403 for controlling overall operation of emerging topic detection computing device 401 and its associated components, including Random Access Memory (RAM) 405, Read-Only Memory (ROM) 407, communications module 409, and memory 415. Emerging topic detection computing device 401 may include a variety of computer readable media. Computer readable media may be any available media that may be accessed by emerging topic detection computing device 401, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by emerging topic detection computing device 401.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on emerging topic detection computing device 401. Such a processor may execute computer-executable instructions stored on a computer-readable medium.

Software may be stored within memory 415 and/or storage to provide instructions to processor 403 for enabling emerging topic detection computing device 401 to perform various functions as discussed herein. For example, memory 415 may store software used by emerging topic detection computing device 401, such as operating system 417, application programs 419, and associated database 421. Also, some or all of the computer executable instructions for emerging topic detection computing device 401 may be embodied in hardware or firmware. Although not shown, RAM 405 may include one or more applications representing the application data stored in RAM 405 while emerging topic detection computing device 401 is on and corresponding software applications (e.g., software tasks) are running on emerging topic detection computing device 401.

Communications module 409 may include a microphone, keypad, touch screen, and/or stylus through which a user of emerging topic detection computing device 401 may provide input, and may also include one or more of a speaker for providing audio output and a video display device for providing textual, audiovisual and/or graphical output. Computing system environment 400 may also include optical scanners (not shown).

Emerging topic detection computing device 401 may operate in a networked environment supporting connections to one or more remote computing devices, such as computing devices 441 and 451. Computing devices 441 and 451 may be personal computing devices or servers that include any or all of the elements described above relative to emerging topic detection computing device 401.

The network connections depicted in FIG. 4 may include Local Area Network (LAN) 425 and Wide Area Network (WAN) 429, as well as other networks. When used in a LAN networking environment, emerging topic detection computing device 401 may be connected to LAN 425 through a network interface or adapter in communications module 409. When used in a WAN networking environment, emerging topic detection computing device 401 may include a modem in communications module 409 or other means for establishing communications over WAN 429, such as network 431 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive customer data;
convert, using natural language processing, the customer data to generate digitized text data associated with a plurality of customer issues;
for a first time period:
generate a first time period body of terms identified from the digitized text data, the first time period body of terms being identified from the digitized text data captured during the first time period;
for a second time period subsequent to the first time period:
generate a second time period body of terms identified from the digitized text data, the second time period body of terms being identified from the digitized text data captured during the second time period;
subtract the first time period body of terms from the second time period body of terms to identify filtered terms appearing in the second time period body of terms but not in the first time period body of terms;
identify the filtered terms appearing in the second time period body of terms but not in the first time period body of terms as emerging terms for the second time period;
execute a machine learning model, executing the machine learning model including using the filtered terms as inputs in the machine learning model to output, by the machine learning model, an emerging topic label; and
store the emerging topic label in a database of labels available to categorize subsequent customer issues.

2. The computing platform of claim 1, wherein the machine learning model uses Latent Dirichlet Allocation (LDA) to analyze the filtered terms.

3. The computing platform of claim 2, further including instruction that, when executed, cause the computing platform to:
executing the machine learning model on the first time period body of terms to identify recurring terms, wherein executing the machine learning model on the first time period body of terms includes using the first time period body of terms as inputs in the machine learning model to output, by the machine learning model, the recurring terms.

4. The computing platform of claim 1, wherein generating the first time period body of terms and the second time period body of terms further includes pre-processing the digitized text data.

5. The computing platform of claim 4, wherein pre-processing the digitized text data includes at least one of: converting all text to lowercase, removing stop words, or removing special characters.

6. The computing platform of claim 1, wherein generating the first time period body of terms and the second time period body of terms includes generating a first document matrix for the first time period and a second document matrix for the second time period.

7. The computing platform of claim 6, wherein subtracting the first time period body of terms from the second time period body of terms to identify filtered terms appearing in the second time period body of terms but not in the first time period body of terms further includes subtracting the first document matrix from the second document matrix.

8. The computing platform of claim 1, further including instructions that, when executed, cause the computing platform to:
transmit the emerging topic label to a computing device, wherein transmitting the emerging topic label to the computing device causes the emerging topic label to display on a display of the computing device.

9. The computing platform of claim 1, wherein the received customer data is voice data.

10. A method, comprising:
receiving, by a computing platform, the computing platform having at least one processor, and memory, customer data;
converting, by the at least one processor and using natural language processing, the customer data to generate digitized text data associated with a plurality of customer issues;
for a first time period:
generating, by the at least one processor, a first time period body of terms identified from the digitized text data, the first time period body of terms being identified from the digitized text data captured during the first time period;
for a second time period subsequent to the first time period:
generating, by the at least one processor, a second time period body of terms identified from the digitized text data, the second time period body of terms being identified from the digitized text data captured during the second time period;
subtracting, by the at least one processor, the first time period body of terms from the second time period body of terms to identify filtered terms appearing in the second time period body of terms but not in the first time period body of terms;
identifying, by the at least one processor, the filtered terms appearing in the second time period body of terms but not in the first time period body of terms as emerging terms for the second time period;
executing, by the at least one processor, a machine learning model, executing the machine learning model including using the filtered terms as inputs in the machine learning model to output, by the machine learning model, an emerging topic label; and
storing, by the at least one processor, the emerging topic label in a database of labels available to categorize subsequent customer issues.

11. The method of claim 10, wherein the machine learning model uses Latent Dirichlet Allocation (LDA) to analyze the filtered terms.

12. The method of claim 11, further including:
executing, by the at least one processor, the machine learning model on the first time period body of terms to identify recurring terms, wherein executing the machine learning model on the first time period body of terms includes using the first time period body of terms as inputs in the machine learning model to output, by the machine learning model, the recurring terms.

13. The method of claim 10, wherein generating the first time period body of terms and the second time period body of terms further includes pre-processing the digitized text data.

14. The method of claim 13, wherein pre-processing the digitized text data includes at least one of: converting all text to lowercase, removing stop words, or removing special characters.

15. The method of claim 10, wherein generating the first time period body of terms and the second time period body of terms includes generating a first document matrix for the first time period and a second document matrix for the second time period.

16. The method of claim 15, wherein subtracting the first time period body of terms from the second time period body of terms to identify filtered terms appearing in the second time period body of terms but not in the first time period body of terms further includes subtracting the first document matrix from the second document matrix.

17. The method of claim 10, further including:
transmitting, by the at least one processor, the emerging topic label to a computing device, wherein transmitting the emerging topic label to the computing device causes the emerging topic label to display on a display of the computing device.

18. The method of claim 10, wherein the received customer data is voice data.

19. One or more non-transitory computer-readable media storing instructions that, when executed by a computing platform comprising at least one processor, memory, and a communication interface, cause the computing platform to:
receive customer data;
convert, using natural language processing, the customer data to generate digitized text data associated with a plurality of customer issues;
for a first time period:
generate a first time period body of terms identified from the digitized text data, the first time period body of terms being identified from the digitized text data captured during the first time period;
for a second time period subsequent to the first time period:
generate a second time period body of terms identified from the digitized text data, the second time period body of terms being identified from the digitized text data captured during the second time period;
subtract the first time period body of terms from the second time period body of terms to identify filtered terms appearing in the second time period body of terms but not in the first time period body of terms;
identify the filtered terms appearing in the second time period body of terms but not in the first time period body of terms as emerging terms for the second time period;
execute a machine learning model, executing the machine learning model including using the filtered terms as inputs in the machine learning model to output, by the machine learning model, an emerging topic label; and
store the emerging topic label in a database of labels available to categorize subsequent customer issues.

20. The one or more non-transitory computer-readable media of claim 19, wherein generating the first time period body of terms and the second time period body of terms includes generating a first document matrix for the first time period and a second document matrix for the second time period.

21. The one or more non-transitory computer-readable media of claim 20, wherein subtracting the first time period body of terms from the second time period body of terms to identify filtered terms appearing in the second time period body of terms but not in the first time period body of terms further includes subtracting the first document matrix from the second document matrix.
